(19) United States
(12) Patent Application Publication
(10) Pub. No.: US 2008/0128460 A1
(43) Pub. Date: Jun. 5, 2008

(54) VEHICLE TRASH SYSTEM

(75) Inventors: Corey S. Adler, Thornhill (CA); Steve A. Copeland, Barrie (CA)

Correspondence Address: SAND & SEBOLT, AEGIS TOWER, SUITE 1100, 4940 MUNSON STREET, NW, CANTON, OH, 44718-3615, US

(73) Assignee: 2111081 ONTARIO LIMITED, Thornhill (CA)

(21) Appl. No.: 11/949,227

(22) Filed: Dec. 3, 2007

Related U.S. Application Data
(63) Continuation-in-part of application No. 11/633,743, filed on Dec. 5, 2006.

(51) Int. Cl. B60R 7/00

(52) U.S. Cl. 224/275

(57) ABSTRACT

A trash container assembly includes a trash receptacle movable between collapsed and expanded positions; and a seat mount for mounting the receptacle on the back of a seat assembly, usually within a vehicle such as an car. Typically, the receptacle includes an accordion type or other collapsible wall and a pair of rigid walls connected to the collapsible wall. A liquid-impermeable trash bag is disposed within the receptacle. A lid is connected to the receptacle and a compartment for pre-moistened wipes or the like is mounted on the lid. The lid and compartment may be positioned atop the receptacle in the expanded position and beside the compartment in the collapsed position. A sidewall of the receptacle may define a recess for receiving the compartment in the collapsed position. The seat mount may include one or more straps for looping around a headrest and the back of the seat assembly.

### CROSS REFERENCE TO RELATED APPLICATION

This application is a continuation in part of U.S. patent application Ser. No. 11/633,743, filed Dec. 5, 2006; the disclosure of which is incorporated herein by reference.

### BACKGROUND OF THE INVENTION

1. Technical Field

The present invention relates generally to a trash receptacle. More particularly, the invention relates to a trash receptacle for use in a vehicle such as an automobile. Specifically, the invention relates to such a trash receptacle which is configured to mount on the back of a seat, is expandable and may provide a separate compartment for pre-moistened wipes or the like.

2. Background Information

It is well known that when traveling in a vehicle such as an automobile, disposing of trash is a common problem, especially when taking a long trip. Often, trash winds up on the floor or in a bag seated on the floor or the like. When a passenger has a drink that is partially finished and that he wishes to dispose of, the remaining liquid in the drink container has the potential of spilling and making a substantial mess within the vehicle. Thus, there is a need in the art for a trash receptacle which is aesthetically pleasing, suited for retaining liquids without causing a mess and capable of maintaining a configuration which will retain the trash therein during various movements of car such as turning, braking and accelerating. The present invention solves this and other problems in the art.

### BRIEF SUMMARY OF THE INVENTION

The present invention provides a trash container assembly for use with a seat assembly having a seat and a back extending upwardly therefrom, the trash container assembly comprising a trash receptacle movable between collapsed and expanded positions; and a seat mount adapted for mounting the receptacle on the back of the seat assembly.

### BRIEF DESCRIPTION OF THE SEVERAL VIEWS OF THE DRAWINGS

FIG. 1 is a perspective view of the trash container assembly of the present invention as shown mounted on the back of a seat in the expanded position and showing the rear of the receptacle.

FIG. 2 is an enlarged perspective view similar to FIG. 1 showing the trash container assembly alone.

FIG. 3 is an exploded perspective view of the assembly in the expanded position showing the front of the receptacle.

FIG. 3A is a perspective view of the flexible bag.

FIG. 4 is a sectional view through the center of the assembly taken from the side showing the receptacle in the expanded position.

FIG. 5 is a perspective view similar to FIG. 2 showing the receptacle in the collapsed position.

FIG. 6 is a side elevational view of the assembly in the collapsed position.

FIG. 7 is a sectional view similar to FIG. 4 in the collapsed position.

FIG. 8 is a perspective view similar to FIG. 1 showing the receptacle mounted on the back of the seat in the collapsed position.

FIG. 9 is a view similar to FIG. 8 showing the receptacle in the expanded position with the lid open.

FIG. 10 is a perspective view of a second embodiment of the trash container assembly of the present invention showing in phantom mounting straps which are not shown in the remaining figures.

FIG. 11 is a sectional view taken on line 11-11 of FIG. 10.

FIG. 12 is an exploded perspective view of the second embodiment.

FIG. 12A is a sectional view taken on FIG. 12A-12A of FIG. 12 showing the pivoting bottom wall in the expanded position.

FIG. 13 is a perspective view of the second embodiment similar to FIG. 10 showing the lid of the wipes container pivoted to an open position.

FIG. 14 is similar to FIG. 13 and shows the lid carrying the wipes container pivoted to an open position.

FIG. 15 is similar to FIG. 14 and shows the main lid pivoted to an open position.

FIG. 16 is a side elevational view of the second embodiment showing the expandable receptacle in a partially collapsed position.

FIG. 17 is a sectional view taken from the same position as FIG. 11 with the receptacle in the fully collapsed position and the lid in a fully collapsed position.

FIG. 17A is a sectional view similar to FIG. 12A showing the pivoting bottom wall and sidewalls in the collapsed position.

FIG. 18 is a side elevational view of the second embodiment in the fully collapsed position.

FIG. 19 is a perspective view of the second embodiment with the receptacle in the fully collapsed position and the main and secondary lids in the collapsed position with the lid to the wipes container shown in an open position.

### DETAILED DESCRIPTION OF THE INVENTION

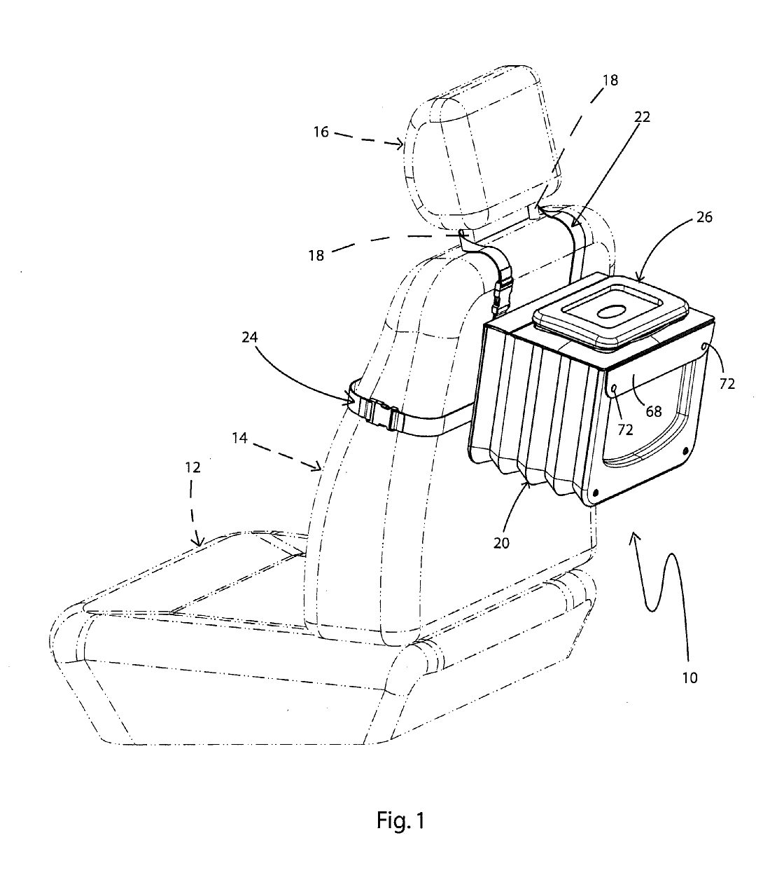

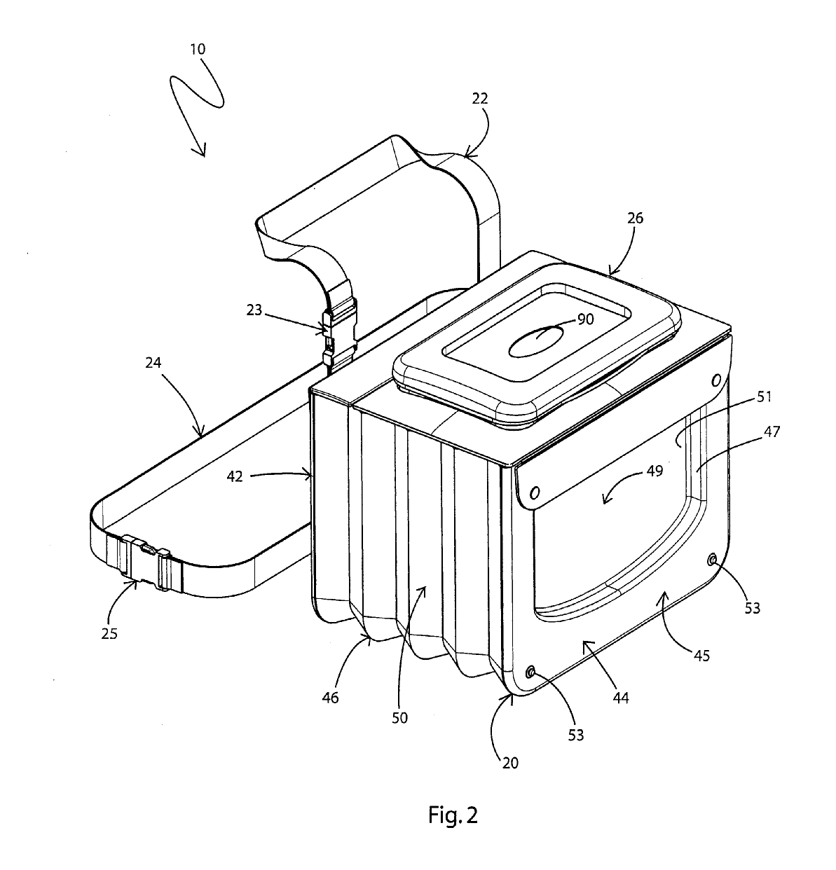

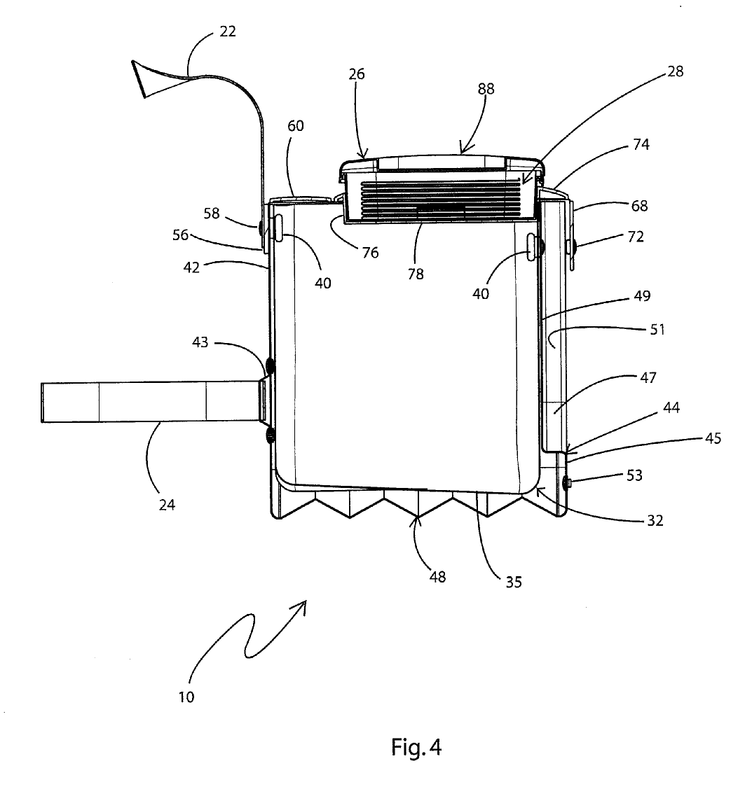

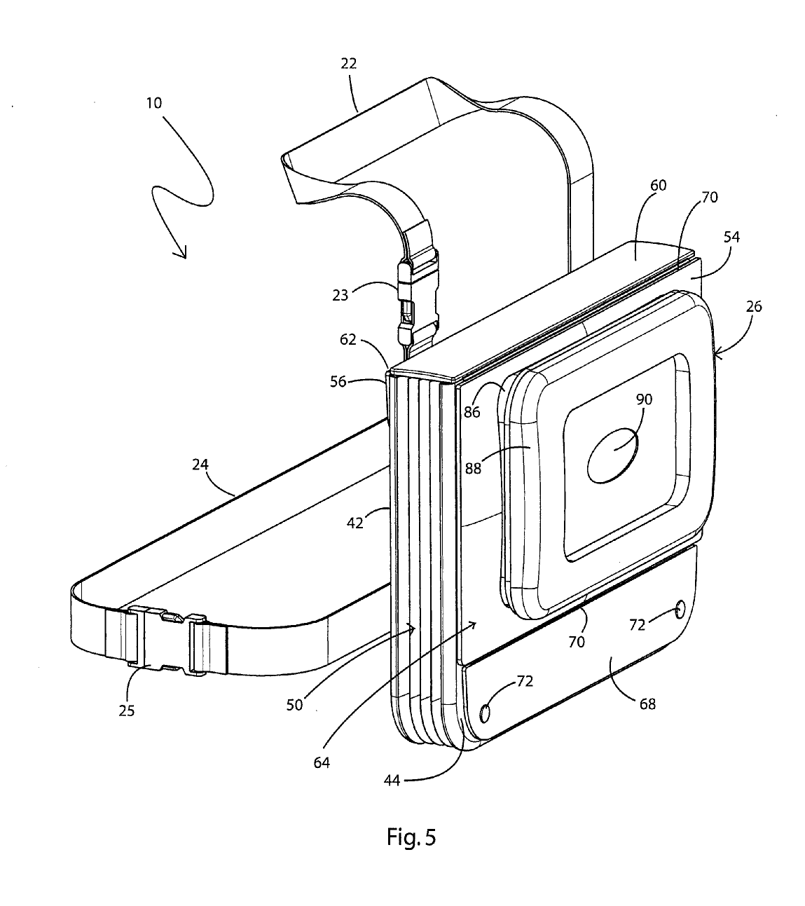

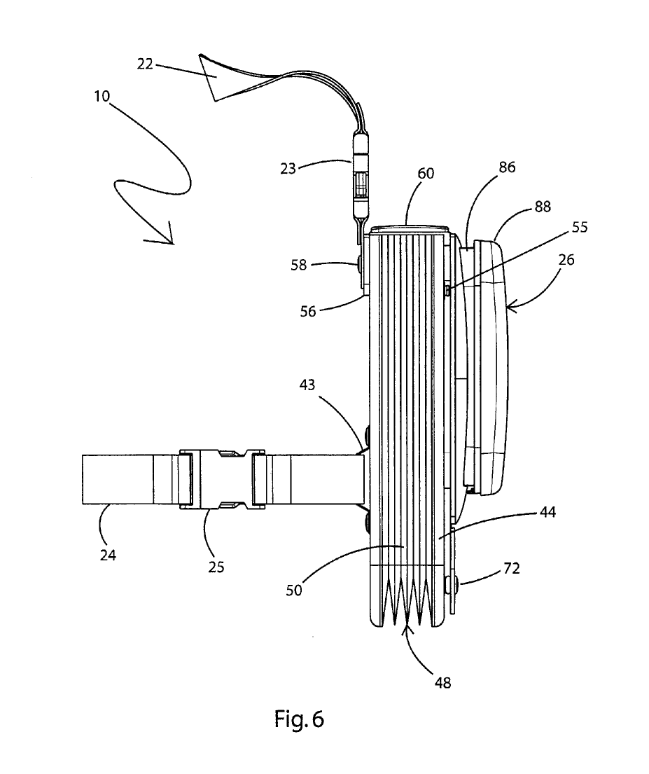

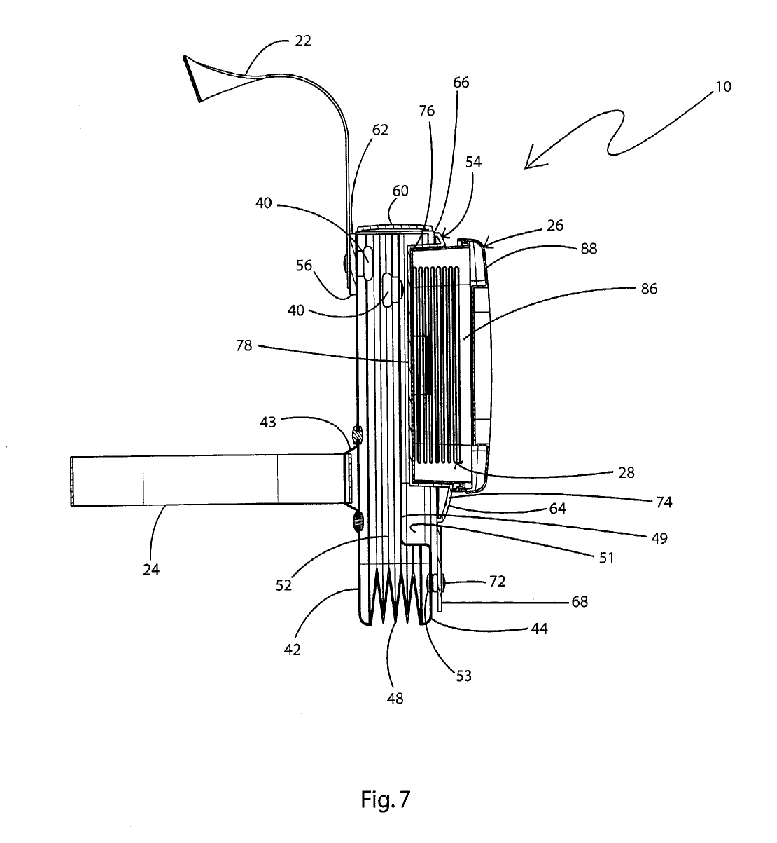

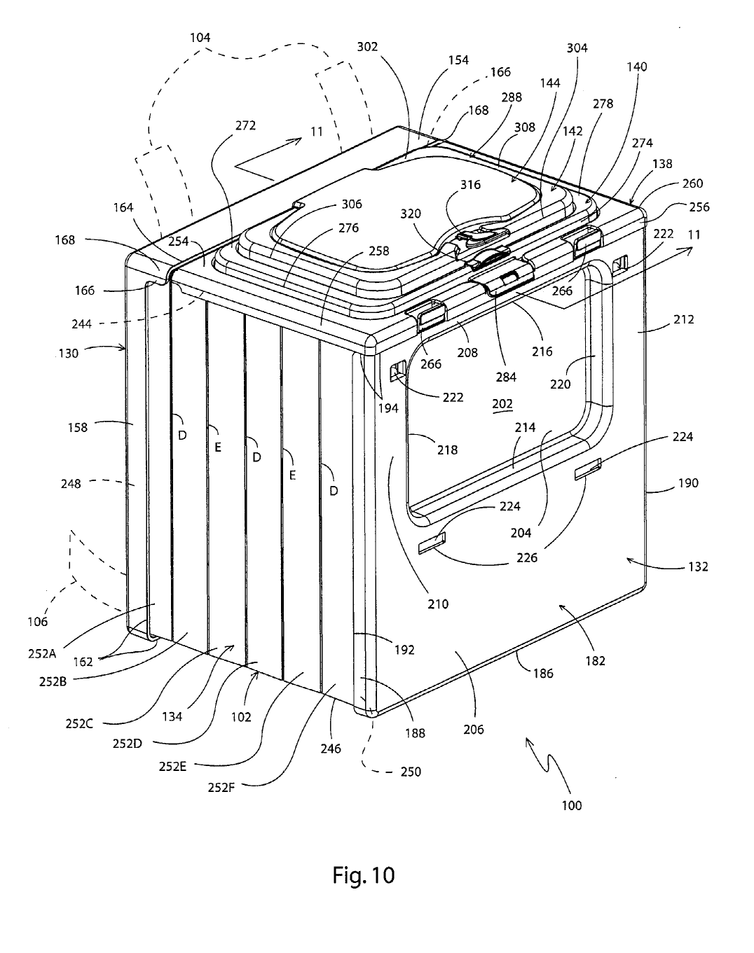

The first embodiment of the trash container assembly of the present invention is indicated generally at 10 in FIGS. 1-3; and a second embodiment of the trash container assembly is indicated generally at 100 in FIG. 10. Assembly 10 is configured primarily for use with a seat or chair such as an automotive seat for receiving trash during travel. Assembly 10 is thus typically used with a vehicular chair having a seat 12, a back 14 extending upwardly therefrom and a headrest 16 mounted on back 14 extending upwardly therefrom via a pair of posts 18 inserted into back 14. Assembly 10 includes a collapsible and expandable receptacle 20 and a seat mount including first and second adjustable straps 22 and 24 which are connected to receptacle 20 and extend outwardly therefrom to form respective loops. Quick release buckles 23 and 25 (FIG. 2) are respectively used with straps 22 and 24 to provide a quick release between the respective sections of said straps. First strap 22 loops around posts 18 of headrest 16 while second strap 24 loops around back 14 in order to secure receptacle 20 on back 14 with the front of receptacle 20 abutting the rear surface of back 14 so that receptacle 20 is snugly mounted on back 14. While the figures show receptacle 20 disposed behind back 14, receptacle 20 may be positioned in front of back 14 and snugly mounted in abutment with the front surface thereof. Assembly 10 may also include a compartment 26 which may be formed inwardly therewith or removably mounted thereon. Compartment 26 preferably is configured to contain pre-moistened wipes 28 (FIGS. 4 and 7), tissues or the like. Receptacle 20 is movable between an expanded position (FIGS. 1-4) and a collapsed position (FIGS. 5-7).

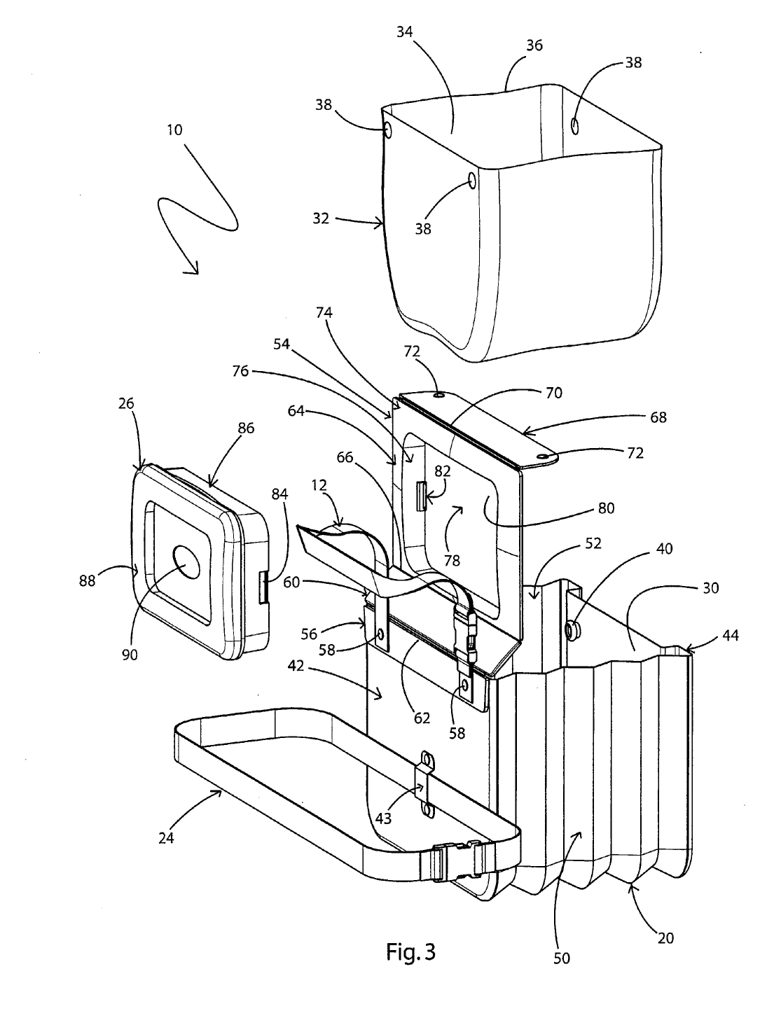

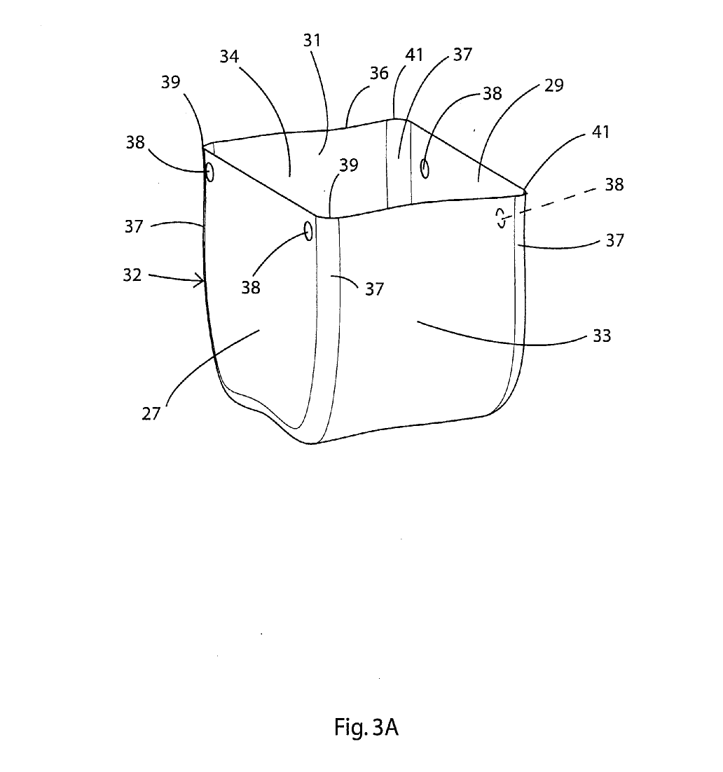

Referring to FIGS. 2-4, receptacle 20 defines an interior chamber 30 in which a flexible trash bag 32 is removably disposed. Bag 32 is preferably liquid-impermeable in order to retain liquids therein. Bag 32 is thus typically formed of a flexible plastic material. However, other bags may be formed of materials which may be liquid permeable if containment of liquids is not necessary. Bag 32 generally conforms to the walls of receptacle 20 so that an interior chamber 34 of bag 32 substantially mimics the interior chamber 30 of receptacle 20. Bag 32 has an upper end 36 defining an entrance opening into interior chamber 34. A plurality of mounting holes 38 are formed in bag 32 adjacent upper end 36 for mounting on respective projections 40 (FIGS. 3, 4 and 9) which extend inwardly from the front and rear walls of receptacle 20.

More particularly, and with reference to FIG. 3A, bag 32 includes a front panel 27, a rear panel 29, first and second side panels 31 and 33 and a bottom panel 35 (FIG. 4). Each of said panels is substantially flat when bag 32 is in an expanded position in order to conform to the respective inner surfaces of receptacle 20 when it is in the expanded position. Bag 32 further includes arcuate transition sections 37 which connect front panel 27 with each of side panels 31 and 33 and also connects rear panel 29 with each of side panels 31 and 33. Each of the arcuate transition sections 37 which are connected to front panel 27 terminate at upper end 36 at respective front upper corners 39 likewise, each of arcuate transition sections 37 which are connected to rear panel 29 terminate at upper end 36 in arcuate rear upper corners 41. A pair of the holes 38 are formed in front panel 27 respectively adjacent front upper corners 39. Likewise, a pair of the holes 38 are formed in rear panel 29 respectively adjacent rear upper corners 41 although the holes formed in panel 29 are slightly lower that those formed in panel 27 to accommodate the respective projections 40, as shown in FIG. 4.

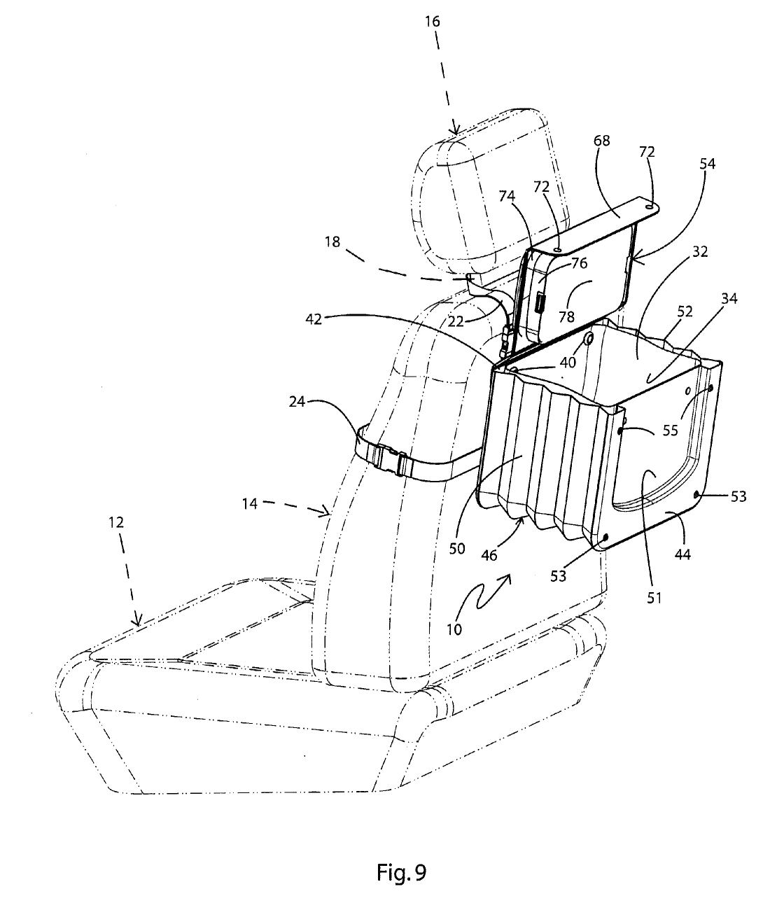

With continued reference to FIGS. 2-4, receptacle 20 includes rigid front and rear walls 42 and 44 which are connected by a collapsible wall in the form of an accordion-type wall 46. Wall 46 thus includes a plurality of panel sections which are folded back and forth in an accordion style so that wall 46 is collapsible and expandable. Wall 46 includes a bottom wall 48 and first and second spaced sidewalls 50 and 52 extending upwardly therefrom. A pair of projections 40 (only one shown) are thus rigidly attached to and extend forward from front wall 44 into interior chamber 30. Likewise, a pair of projections 40 (FIG. 9) extends rearwardly from front wall 42 into interior chamber 30. A mounting bracket 43 is mounted on front wall 42 for mounting thereon second strap 24.

Rear wall 44 includes a U-shaped outer wall 45 defining a U-shaped inner perimeter, a U-shaped sidewall 47 extending inwardly from the inner perimeter of outer wall 45 and a flat recessed wall 49 connected to sidewall 47 and disposed inwardly of outer wall 45 to form a recessed area 51. A lower set of first fastening members 53 is mounted on outer wall 44 adjacent its lower end. Similarly, an upper set of first fastening members 55 (FIG. 9) is mounted on outer wall 45 adjacent its upper end.

A foldable lid 54 formed of rigid or suitably rigid materials is pivotally mounted on receptacle 20 and movable between closed and open positions respectively shown in FIGS. 2 and 3. Lid 54 includes a mounting flange 56 which is secured to front wall 42 by a pair of fasteners 58 which also secure the projections 40 mounted on front wall 42. Fasteners 58 also secure respective ends of first strap 22 to front wall 42. Lid 54 further includes a spine panel 60 which is hingedly connected to mounting flange 56 by a hinge 62 such as a living hinge. Lid 54 further includes a main or top panel 64 hingedly connected to panel 60 by another hinge 66 which is typically a living hinge. A closing panel or flap 68 is hingedly mounted to main panel 64 by another hinge 70 which is also typically a living hinge. Hinges 62, 66 and 70 are parallel to one another. A pair of fastening members 72 is mounted on flap 68 for releasably securing flap 68 to receptacle 20 as further detailed below. Second fastening members 72 may alternately releasably engage upper first fastening members 55 or lower first fastening members 53 depending on the position of expandable receptacle 20.

Main wall 64 includes a rectangular top wall 74 which defines an inner perimeter, a rectangular sidewall 76 extending downwardly from the inner perimeter of top wall 74 and a flat recessed wall 78 disposed downwardly from top wall 74 and connected to sidewall 76 to form a recessed area 80 extending downwardly from top wall 74 when lid 54 is in the closed position. A retaining mechanism in the form of a pair of opposed retaining clips 82 (one shown in FIG. 3) is mounted on sidewall 76 for releasably securing compartment 26 when disposed within recess 80.

More particularly, a pair of retaining recesses 84 (one shown in FIG. 3) is formed in a base 86 of compartment 26 for releasably receiving clips 82. Base 86 thus comprises a generally rectangular bottom wall and generally rectangular sidewall which fits matingly within recess 80 with the bottom wall abutting recessed wall 78. Compartment 26 further includes a lid 88 which is openable and closable to allow for the insertion and removal of wipes 28 (FIG. 4). An access opening 90 may also be formed in lid 88 to allow for removal of wipes 28 therethrough while being configured to retain moisture within compartment 26.

When receptacle 20 is in the expanded position with walls 42 and 44 spaced apart, spine panel 60, top wall 74 and recessed wall 78 are generally horizontal and flap 68 is generally vertical and releasably connected to front wall 44 via the releasable connection between upper fastening members 55 and second fastening members 72. In the collapsed position of receptacle 20 shown in FIGS. 5-7, rear wall 44 moves toward front wall 42 while maintaining a generally vertical position of each of said walls as wall 46 collapses. In this collapsed position with lid 54 closed, spine panel 60 remains in a substantially horizontal position while main panel 64 has pivoted downwardly via hinge 66 so that top wall 74 and recessed wall 78 are substantially vertically oriented along with flap 68 which is releasably connected to rear wall 44 via the releasable connection between connecting members 53 and 72. Thus, when assembly 10 is not in use, it may be stored in the relatively compact position shown in FIGS. 5-7 with front and rear walls 42 and 44 substantially parallel to back 14 or the rear surface thereof. To help achieve this compact configuration, recessed wall 78 and sidewall 76 are received within recessed area 51 of front wall 44.

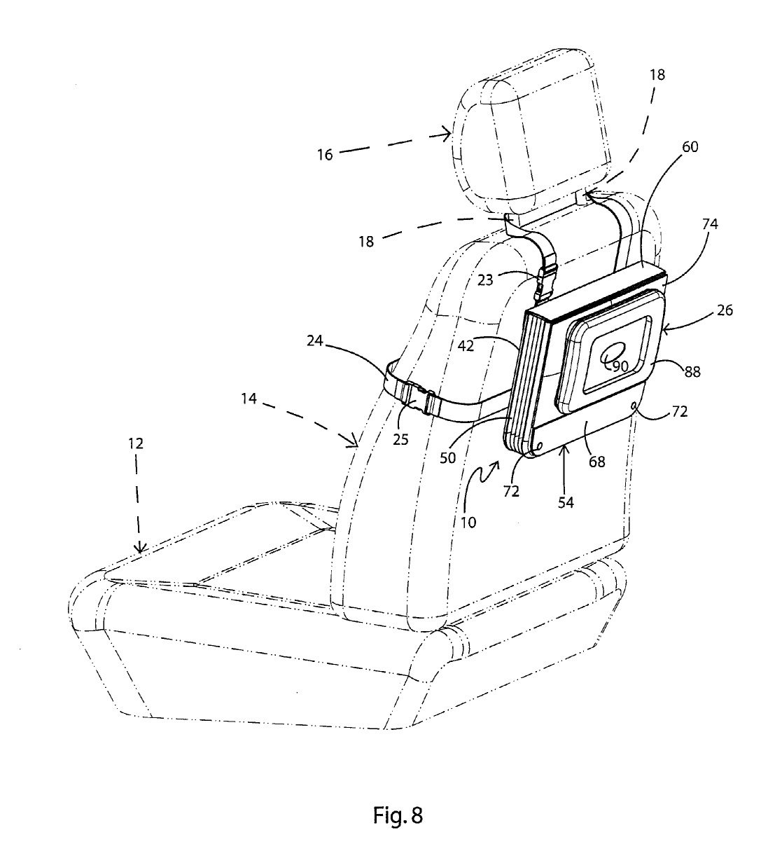

Referring to FIGS. 8-9, the operation of assembly 10 is further detailed. To install assembly 10, first strap 22 is looped around posts 18, secured with buckle 23 and tightened as needed. Second strap 24 is also looped around back 14, buckled with 25 and tightened as needed to secure receptacle 20 on back 14 preferably abutting the rear surface thereof and snuggly secured thereto to prevent the tipping of receptacle 20 and bag 32. Wipes 28, tissues or the like may be removed from compartment 26 via opening 90 or by opening lid 88 regardless of the position of receptacle 20. In order to use receptacle 20, fastening members 72 are released from fastening members 53 so that lid 54 may be pivoted upwardly via the hinge or hinges thereof so that rear wall 44 may move rearwardly via the expansion of wall 46. Lid 54 may then be opened as shown in FIG. 9 to allow access to interior chamber 34 of bag 32 in order to dispose trash therein. Lid 54 may then be lowered with receptacle 20 in the expanded position and flap 68 secured to the upper portion of wall 44 via the releasable connection of fastening members 72 and 55, as shown in FIG. 1.

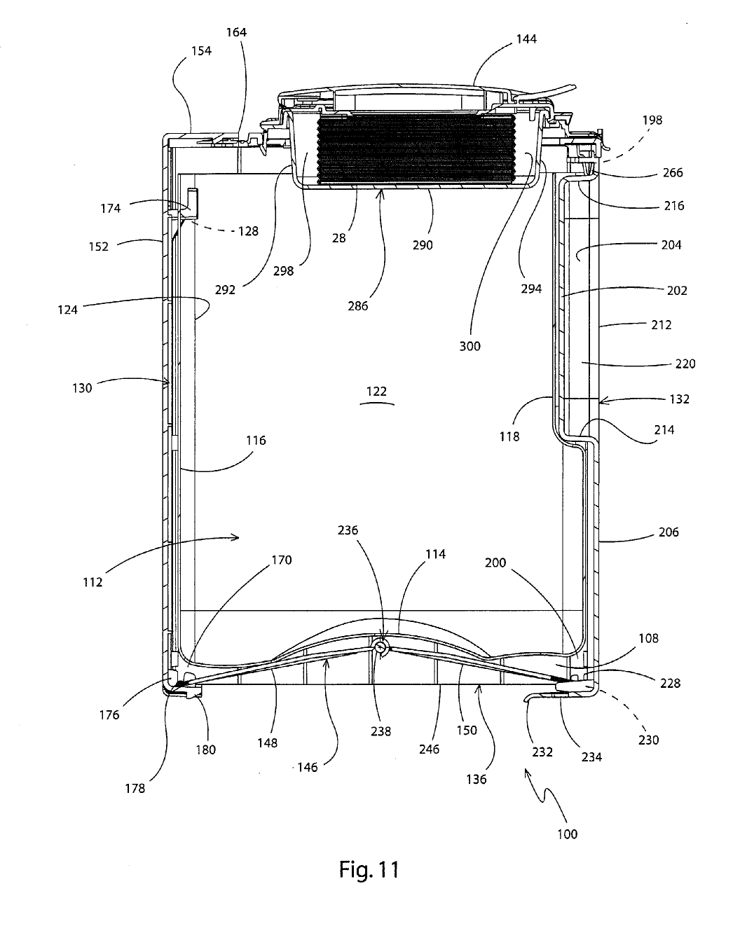

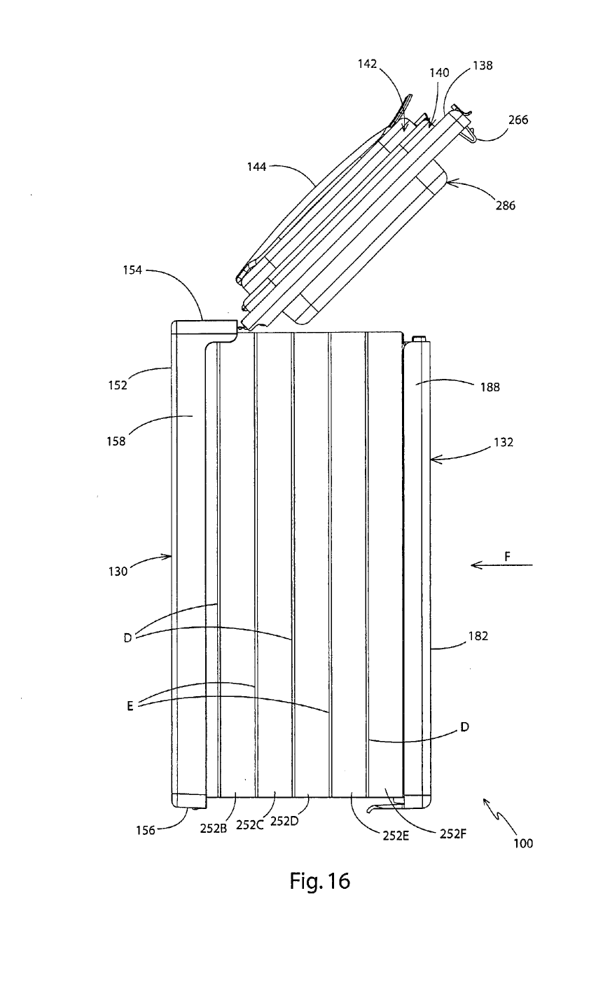

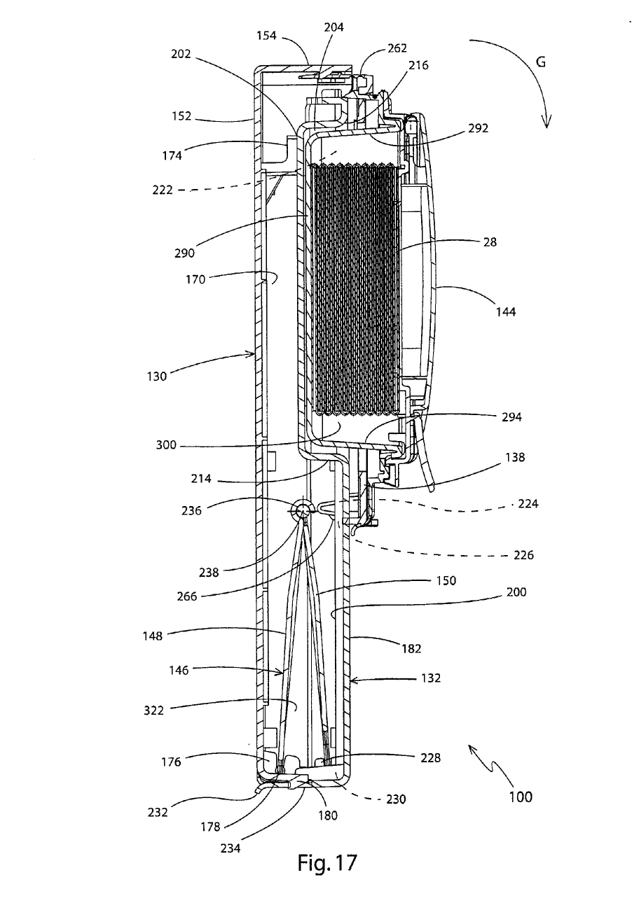

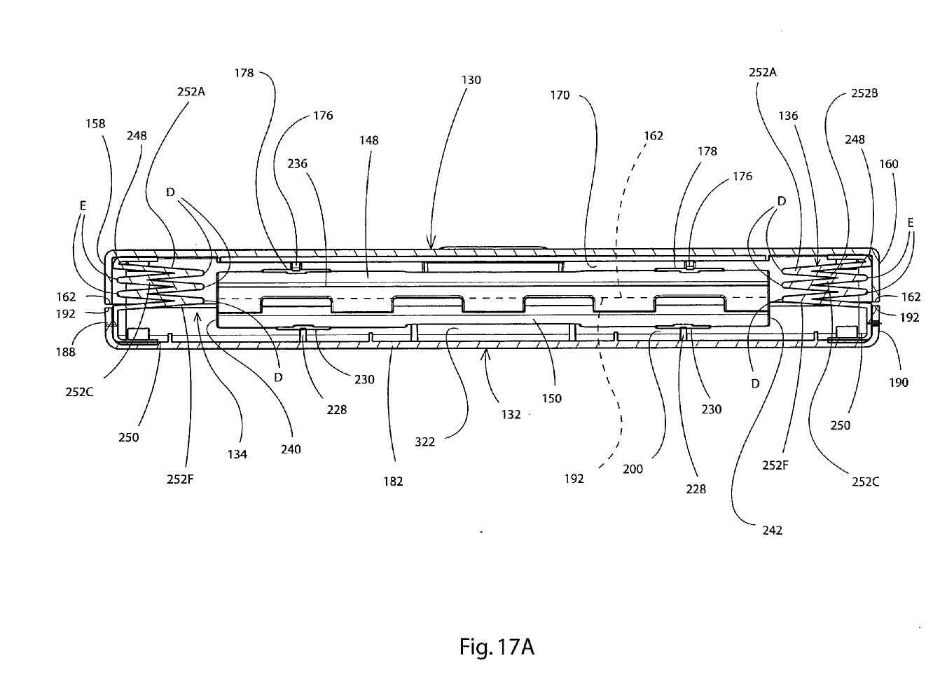

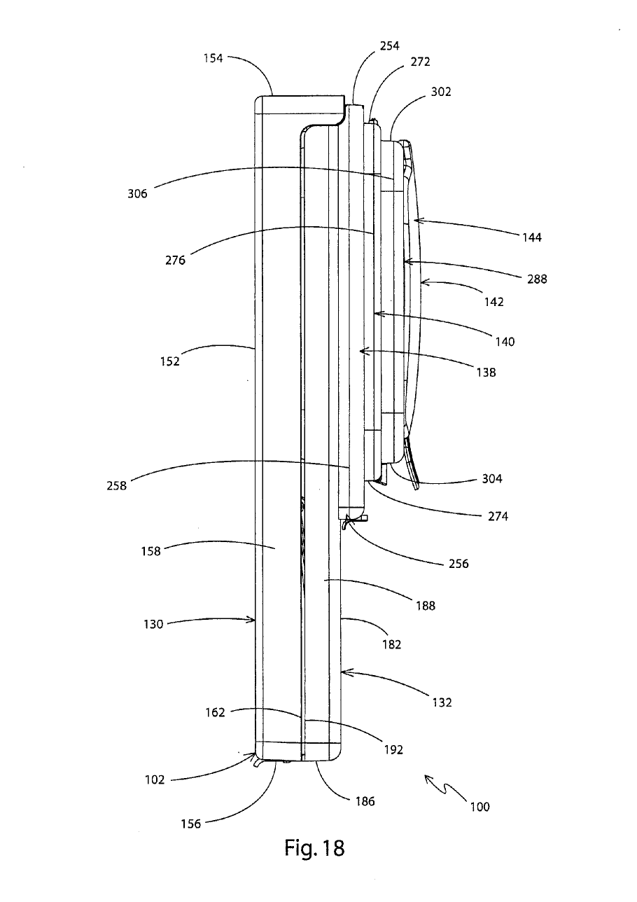

Trash container assembly 100 is now described with reference to FIGS. 10-19. As shown in FIG. 10, assembly 100 includes an expandable and collapsible receptacle 102 with first and second straps 104 and 106 (phantom lines) connected thereto and serving as a mounting mechanism for mounting assembly 100 on the back of a seat in the same manner discussed with reference to trash container assembly 10. Straps 104 and 106 are only partially shown for simplicity. Receptacle 102 has an expanded position shown in FIGS. 10 and 11 and a fully collapsed position shown in FIGS. 17 and 18 with a partially expanded or collapsed position shown in FIG. 16. Receptacle 102 defines an interior chamber 108 having an entrance opening 110 at its top for removably receiving a flexible and preferably liquid-impermeable bag 112 similar to bag 32 of assembly 10. Bag 112 includes a bottom wall 114, front and rear walls 116 and 118, and first and second sidewalls 120 and 122 wherein walls 116, 118, 120 and 122 are connected to and extend upwardly from bottom wall 114 so that bag 112 forms an interior chamber 124 with an entrance opening 126 at the top thereof.

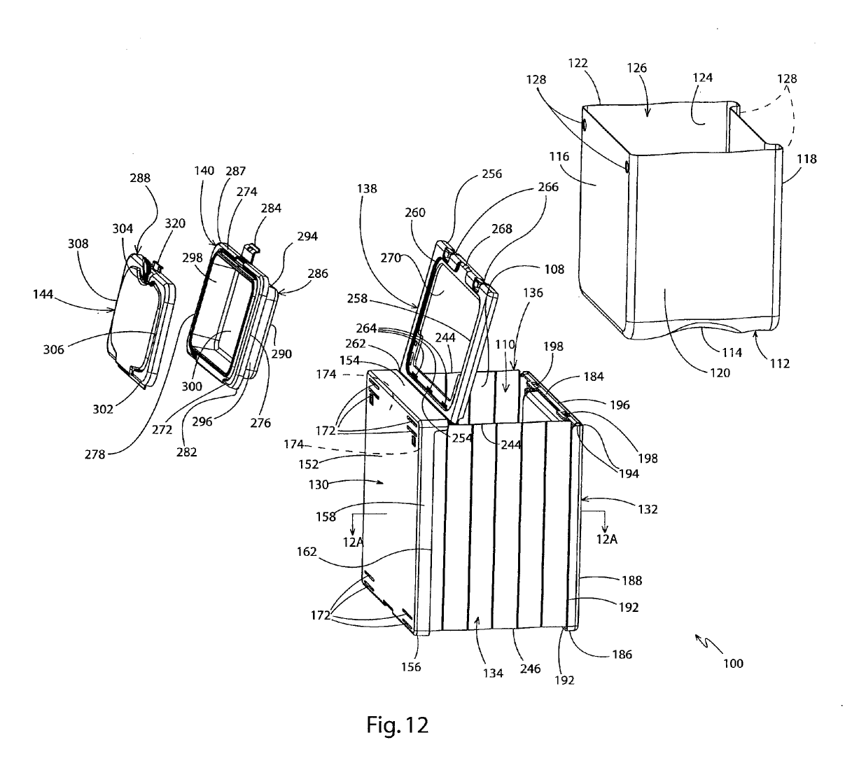

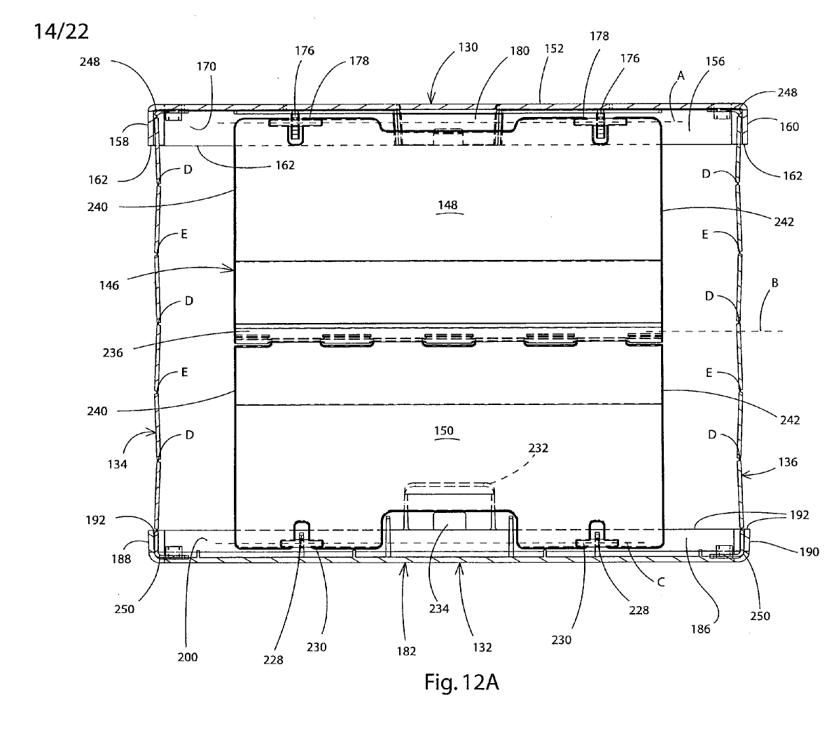

Receptacle 102 includes a front wall 130, a rear wall 132 and first and second collapsible sidewalls 134 and 136 shown here in the form of accordion style walls. Receptacle 102 further includes a rectangular primary or main first lid 138 and a smaller rectangular secondary or second lid 140 mounted on lid 138. A compartment or container 142 is mounted on second lid 140 and includes its own third lid 144. A foldable or pivoting bottom wall 146 (FIGS. 11, 12A) includes front and rear wall sections or panels 148 and 150. Front wall 130, rear wall 132, main lid 138, second lid 140, container 142 including lid 144, panel 148 and panel 150 are formed from substantially rigid materials such as a rigid plastic although other substantially rigid materials may be used. While these materials are substantially rigid, they nonetheless typically allow some flexing for use of the various latching members described further below.

Front wall 130 includes a flat rectangular vertically oriented base wall 152, a flat rectangular horizontal top perimeter wall 154 connected to the top of base wall 152 and extending perpendicularly rearward therefrom, a flat rectangular horizontal bottom perimeter wall 156 connected to the bottom of base wall 152 and extending perpendicularly rearwardly therefrom, and first and second flat rectangular vertical perimeter sidewalls 158 and 160 (FIG. 12A) connected respectively to the sides of base wall 152 and extending perpendicularly rearwardly therefrom. Each of sidewalls 158 and 160 extends perpendicularly between and is connected to top and bottom walls 154 and 156. Perimeter walls 154, 156, 158 and 160 together form a continuous outer perimeter wall extending rearwardly from the outer perimeter of base wall 152. Each of bottom wall 156 and sidewalls 158 and 160 extend rearwardly to respective terminal edges 162 which are coplanar and parallel to base wall 152 so that each of said walls has a width from front to back which is the same. Top wall 154 extends from its front end connection to base wall 152 rearwardly to horizontal rear terminal edge 164 spaced rearwardly of terminal edges 162 so that top wall 154 has a width from front to rear which is greater than that of bottom 156 and sidewalls 158 and 160. In the exemplary embodiment, the width of top wall 154 from front to back is approximately twice that of bottom wall 156 and sidewalls 158 and 160 although this may vary. Each of sidewalls 158 and 160 includes an upper extension 166 at its respective upper end which extends horizontally rearwardly from its vertical portion and is connected to top wall 154 by a respective arcuate corner 168 to provide additional rigidity to top wall 154. The five walls of front wall 130 define therewithin a rearwardly opening cavity 170.

A plurality of narrow strap-receiving through openings 172 are formed in base wall 152 and communicate with cavity 170. Openings 172 (FIG. 12) are configured to receive therethrough one of straps 104 and 106 for mounting said straps on front wall 130. In the exemplary embodiment, a pair of vertically spaced openings 172 is formed adjacent each of the four corners of base wall 152. It is noted that any suitable mounting mechanism may be used to mount straps 104 and 106 on the receptacle. For instance, D-rings or the like may be mounted on wall 130 and extend outwardly therefrom to receive the straps therethrough. Such rings may be permanently mounted or removably mounted, as with snaps, that is, respective snap members on each ring and on the front of wall 130. A pair of horizontally spaced projections or hooks 174 is connected to base wall 152 respectively adjacent its upper corners and extends rearwardly within cavity 170 and then upwardly a short distance to a terminal end. Hooks 174 are removably received in the front holes 178 of trash bag 112 to hang bag 112 within interior chamber 108. A pair of horizontally spaced slotted mounting brackets 176 (FIGS. 11, 12A) are connected to and extend upwardly from bottom wall 156 so that the slots thereof respectively receive a pivot 178 connected to front panel 148 at its front end. A centrally located bottom latching member 180 (FIGS. 11, 12A) is connected to base wall 152 at its bottom end in a cantilever fashion and extends rearwardly therefrom about the same distance as the width of bottom wall 156. It is noted that the use herein of the word “latch” or any form thereof is intended to relate to a releaseable connection or securing engagement in which the release does not require the use of a key. Thus, for instance, two latching members releaseably engage one another to form a latching engagement therebetween.

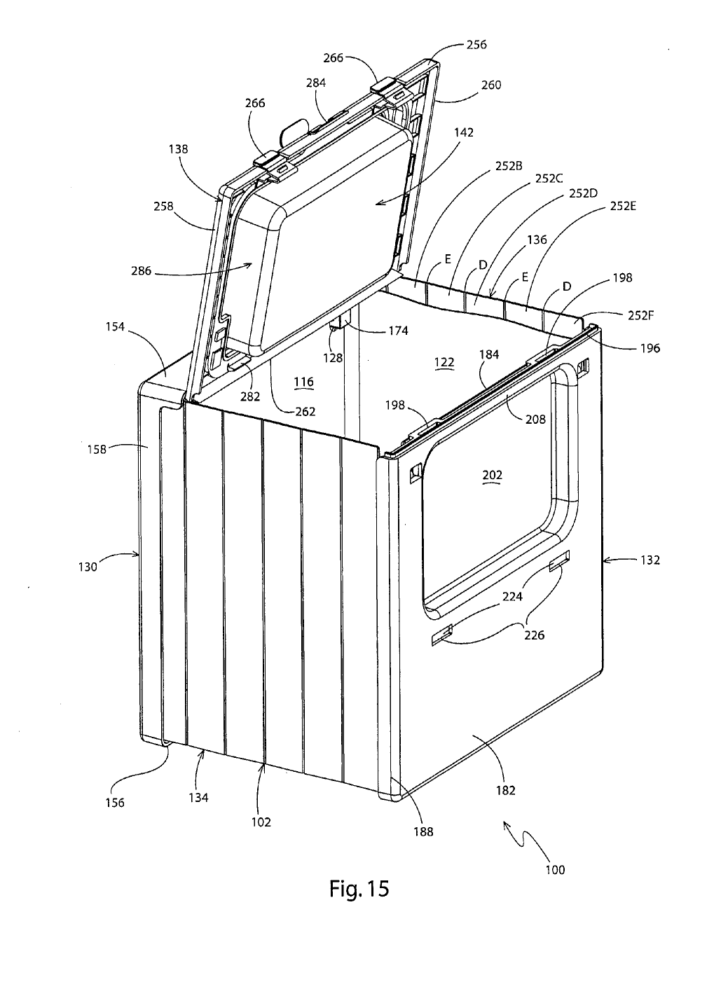

Rear wall 132 includes a flat vertical base wall 182 having a substantially rectangular outer perimeter, a generally rectangular flat horizontal top perimeter wall 184 connected to the top of base wall 182 and extending forward therefrom, a flat horizontal bottom perimeter wall 186 connected to the bottom of base wall 182 and extending forward therefrom, and first and second flat vertical perimeter sidewalls 188 and 190 connected respectively to the sides of base wall 182 and extending perpendicularly forward therefrom. Perimeter walls 184, 186, 188 and 190 together form a continuous outer perimeter wall extending forward from the outer perimeter of base wall 182. Each of bottom wall 186 and sidewalls 188 and 190 have a forward facing terminal edge 192 each of which is coplanar and parallel to base wall 182. Each of base wall 182 and sidewalls 188 and 190 has an upwardly facing horizontal top edge 194 which together form a generally U-shaped configuration. A horizontal U-shaped lip 196 (FIGS. 12, 15) is connected to top wall 184 immediately forward of base wall 182 and immediately inward of sidewalls 188 and 190 and extends upwardly a short distance above top edge 194, paralleling base wall 182 and sidewalls 188 and 190. FIG. 12 also shows a pair of horizontally spaced latch-receiving openings 198 formed in top wall 184 so that portions of top wall bounding openings 198 serve as latch members. Base wall 182, top wall 184, bottom wall 186 and sidewalls 188 and 190 define therewithin a forward opening cavity 200 which faces cavity 170.

Rear wall 132 further includes a flat vertical rectangular recessed wall 202 which is parallel to and spaced forward of base wall 182 and bounds a rearwardly opening cavity or recess 204 which extends inwardly and forward from the rear surface of base wall 182. Thus, base wall 182 includes a rectangular lower wall portion 206 disposed below recess 204 and making up about half the height of base wall 182, a narrow laterally elongated upper wall portion above recess 204, and first and second vertically elongated sidewall portions 210 and 212 on either side of recess 204. A horizontal lower connecting wall 214 is spaced upwardly from bottom wall 186 and is connected to the upper end of lower wall portion 206 and extends forward therefrom to connect to the lower end of recessed wall 202. A horizontal upper connecting wall 216 spaced downwardly a short distance from top wall 184 is connected to the lower end of upper wall portion 208 and extends forward therefrom to connect to the upper end of recessed wall 202. A first vertical lateral connecting wall 218 spaced inwardly from first sidewall 188 is connected to the inner edge of first sidewall portion 210 and extends forward therefrom to connect to a first lateral edge of recessed wall 202. Likewise, a second vertical lateral connecting wall 220 spaced inwardly from second sidewall 190 is connected to the inner edge of second sidewall portion 212 and extends forward therefrom to connect to a second opposed lateral edge of recessed wall 202. Each of connecting walls 214, 216, 218 and 220 thus extend forward within cavity 200 and together form a continuous inner perimeter wall.

A pair of horizontally spaced projections or hooks 222 (FIG. 10) with a configuration like hooks 174 but in a reversed orientation are respectively connected to first and second sidewall portions 210 and 212 of base wall 182 and extend forward therefrom within cavity 200. Like hooks 174, hooks 222 are received within the rear holes 128 of bag 112 for hanging bag 112 therefrom. Hooks 222 are disposed respectively adjacent the opposite ends of upper wall portion 208 and respectively adjacent the upper corners of base wall 182 with the upper portion of recess 204 directly therebetween. A pair of horizontally spaced latch-receiving openings 224 are formed in lower wall portion 206 a short distance below recess 204 and respectively adjacent the opposed ends of lower connecting wall 214. Respective portions of lower wall portion 206 which respectively bound openings 224 serve as latching members 226 as discussed further below. Openings 224 and latching members 226 are respectively substantially vertically aligned with and spaced downwardly from openings 198 in top wall 184 for alternately forming a latching engagement with respective latching members 226 when lid 138 is in its collapsed position (FIGS. 17-19). A pair of spaced slotted mounting brackets 228 are connected to and extend upwardly from bottom wall 186 whereby the slots therein respectively receive pivots 230 connected to the rear end of rear panel 150 of folding bottom wall 146, as shown in FIGS. 11 and 12A. A latching member 232 is connected to bottom wall 186 centrally between mounting bracket 228 and extends forward therefrom. A latch-receiving opening 234 is formed in latching member 232 for receiving latching member 180 of front wall 130 to form a releasable latching engagement to secure front and rear walls 130 and 132 to one another in the collapsed position (FIG. 17).

With continued reference to FIGS. 11 and 12A, the rear end of front panel 148 and the front end of rear panel 150 are pivotally or hingedly connected to one another by a hinge 236 about a laterally extending pivot 238. Thus, panels 148 and 150 pivot relative to one another and relative to front and rear walls 130 and 132 about three parallel laterally extending horizontal axes A, B, and C (FIG. 12A) which pass respectively through pivots 178, 238 and 230. FIG. 12A also shows that each of panels 148 and 150 has first and second opposed side edges 240 and 242. Side edge 240 of each panel is spaced inwardly from first sidewalls 158 and 188 a sufficient distance to accommodate the folding of first accordion sidewall 134 in the collapsed position (FIG. 17A). Likewise, second side edge 242 of each of the panels is spaced inwardly of second sidewalls 160 and 190 a sufficient distance to allow for the folding of second accordion wall 136 in the collapsed position.

Each of sidewalls 134 and 136 has a top edge 244, a bottom edge 246, a front edge 248 and a rear edge 250. Each of walls 134 and 136 is generally flat and rectangular in the expanded position and includes a plurality of vertical rectangular folding panels 252A-F which are serially connected to one another at respective folds or creases D and E each in the form of a living hinge. Folds D and E also represent vertical axes which are perpendicular to axes A-C and about which the respective panels 252 pivot relative to one another. The vertical folds D and E alternate with one another as shown in FIG. 10 so that folds D represent inner folds and folds E represent outer folds which are disposed outwardly of folds D in the collapsed position as shown in FIG. 17A. Front edge 248 of first sidewall 134 is connected to front wall 130 adjacent the intersection of base wall 152 and sidewall 158. Likewise, front edge 248 of second sidewall 136 is pivotally connected to front wall 130 adjacent the intersection of base wall 152 and sidewall 160. Rear edge 250 of first sidewall 134 is pivotally connected to rear wall 132 adjacent the intersection of base wall 182 and first sidewall 188. Likewise, rear edge 250 of second sidewall 136 is pivotally connected to rear wall 132 adjacent the intersection of base wall 182 and sidewall 190. Bottom edge 246 of each sidewall 134 and 136 is adjacent and spaced upwardly from each of bottom walls 156 and 186. Top edge 244 of each of sidewalls 134 and 136 is adjacent and spaced downwardly from top wall 154 of front wall 130.

Main lid 138 includes a laterally extending front wall 254, a laterally extending rear wall 256 parallel to wall 254, and first and second spaced parallel sidewalls 258 and 260 extending perpendicularly between and connected to each of front and rear walls 254 and 256 at opposite ends thereof. Front wall 254 is pivotally connected to top wall 154 of front wall 130 adjacent its rear terminal edge 164 via a hinge 262 (FIG. 12) whereby main wall 138 is pivotable about an axis parallel to axes A, B and C between a closed position (FIG. 10) and an open position (FIG. 12) when receptacle 102 is in the expanded position. Three pivot-receiving openings 264 (FIG. 12) are formed in front wall 254 and are laterally spaced from one another. A pair of laterally spaced latching members 266 are connected to rear wall 256 and are respectively received within openings 198 in top wall 184 of rear wall 132 in the closed position of main lid 138 to form a latching engagement with top wall 184 adjacent the top of rear wall 132 and rear end of lid 138 opposite its front end pivotal connection to top wall 154. A central latching member 268 (FIG. 12) is connected to front wall 254 centered between latching members 266. A rectangular central through opening 270 (FIG. 12) is formed in main lid 138 and bounded by each of front and rear walls 254 and 256 and sidewalls 258 and 260.

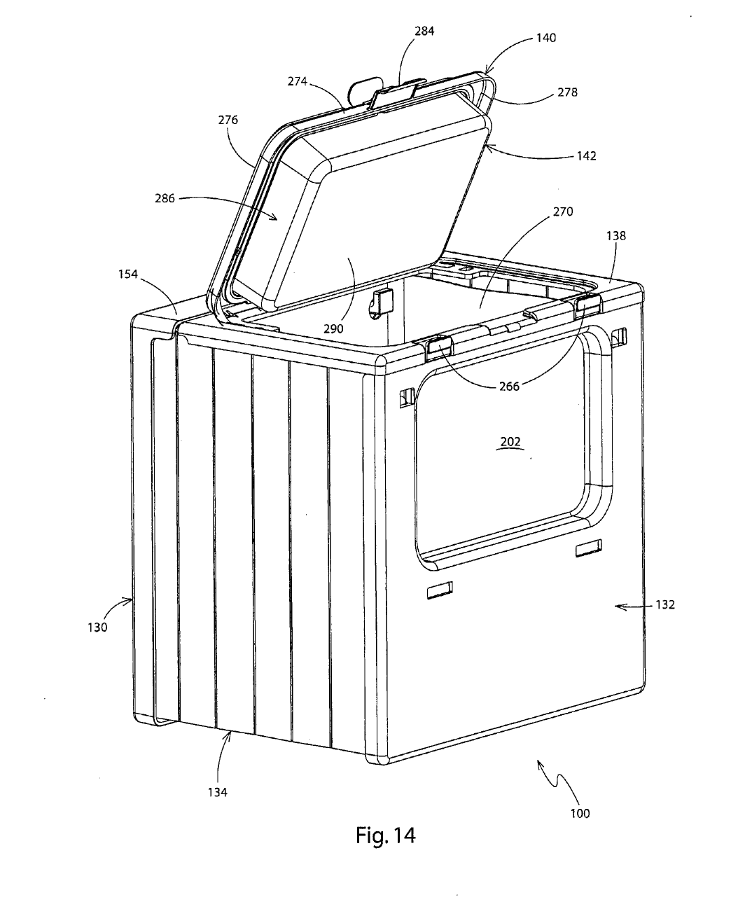

Second lid 140 includes wipes container 142 which includes a base 286, a rectangular flange 287 connected to and extending outwardly from adjacent the top of base 286, and a cover 288. Flange 287 and base 286 are typically formed as an integral one-piece member. Flange 287 includes parallel laterally extending front and rear walls 272 and 274. Flange 287 further includes spaced parallel first and second sidewalls 276 and 278 which extend perpendicularly between and are connected to front and rear walls 272 and 274. A plurality of pivots 282 are connected to and extend outwardly from front wall 272 and are received within pivot-receiving openings 264 of main lid 138 whereby second lid 140 is pivotally mounted on main lid 138 about an axis parallel to axes A, B and C between a closed position (FIG. 10) and an open position (FIG. 14). Flange 287 is seated atop inner portions of each of the walls of main lid 138 when second lid 140 is closed. A latching member 284 is connected to the center of rear wall 274 and projects outwardly therefrom to releaseably form a latching engagement with latching member 268 of main lid 138 in the closed position of second lid 140.

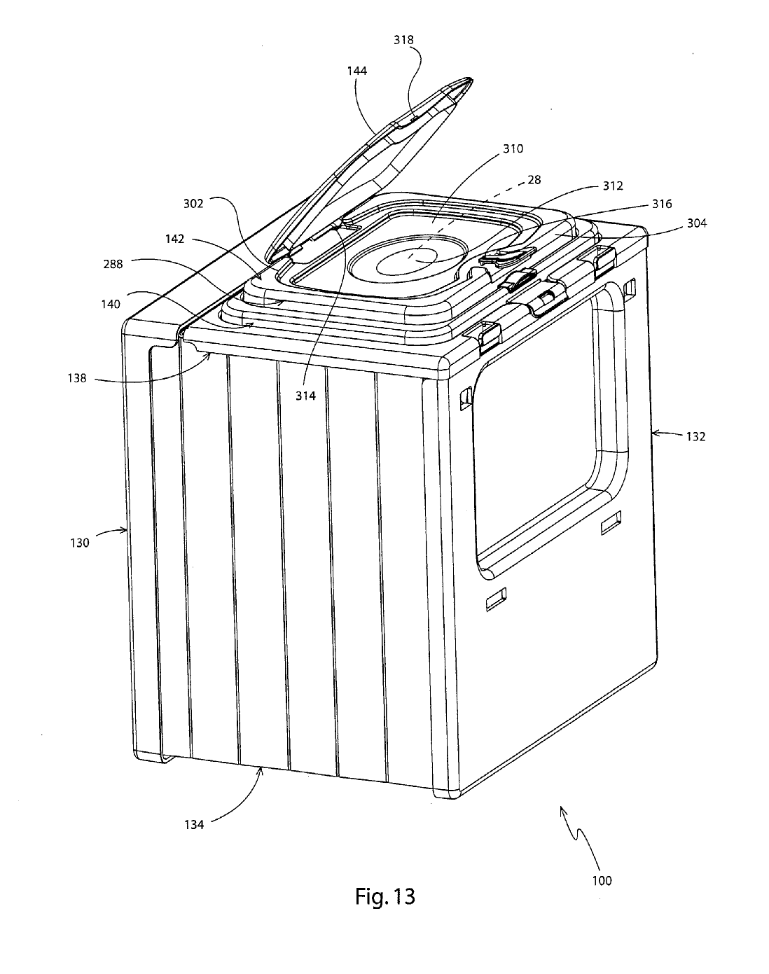

Cover 288 of wipes container 142 is removably mounted on the top of base 286 to allow for refilling container 142 with wipes 28 when cover 288 is removed. Base 286 includes a flat horizontal bottom wall 290. A front wall 292 (FIG. 11), a rear wall 294, first sidewall 296 (FIG. 12) and second sidewall 298 (FIG. 11) are connected to and extend upwardly from bottom wall 290 to define therewithin an interior chamber 300 (FIG. 11) in which wipes 28 are stored. Cover 288 includes front and rear laterally extending parallel walls 302 and 304, and first and second parallel sidewalls 306 and 308 extending perpendicularly between and connected to front and rear walls 302 and 304. Cover 288 further includes a recessed wall 310 (FIG. 13) with an access opening 312 formed centrally therein for manually accessing wipes 28 from within interior chamber 300 when third lid 144 is in the open position shown in FIG. 13. Lid 144 is pivotally mounted on front wall 302 of cover 288 via a hinge 314 about an axis parallel to axes A, B and C to pivot between the closed position of FIG. 10 and open position of FIG. 13. A latching member 316 is connected to rear wall 304 of cover 288 and forms a releaseable latching engagement with a latching member 318 formed centrally at the rear of lid 144 when lid 144 is in its closed position.

Thus, main lid 138 is the largest of the rectangular lids, second lid 140 is smaller than lid 138, cover 288 of container 142 is smaller than second lid 140, and lid 144 is smaller than cover 288. Due to the rectangular structure of each of the lids and cover, the various front and rear walls thereof are parallel to one another, as are the various sidewalls thereof. The lids are stacked and nested somewhat so that in the expanded position of receptacle 102, each lid is higher than the one on which it is mounted as the lids go from largest to smallest. Thus, second lid 140 is seated on main lid 138 and has an upper surface higher than the upper surface of lid 138. Likewise, cover 288 is seated on second lid 140 and has an upper surface higher than that of the upper surface of lid 140. Similarly, lid 144 is seated on cover 288 and has an upper surface higher than that of cover 288. Receptacle 102 has two rectangular upper entrance openings for accessing interior chamber 108 and interior chamber 124 of bag 112 when disposed in interior chamber 108. More particularly, these entrance openings are entrance opening 110 bounded by front and rear walls 130 and 132 and sidewalls 134 and 136 and entrance opening 270 which is formed in main lid 138 and is smaller than entrance opening 110. Main lid 138 thus covers the outer perimeter of entrance opening 110 when lid 138 is in its closed position with receptacle 102 in its expanded position. Second lid 140 entirely covers entrance opening 270 with flange 287 covering the outer perimeter of entrance opening 270 when closed and latched to main lid 138. Thus, components 138, 140 and 142 together serve as a lid which is pivotally mounted on top wall 154 and moveable between a closed position in which it completely covers entrance opening 110 in an open position allowing access to entrance opening 110. Likewise, component 140 by itself or components 140 and 142 together form a lid which is moveable between a closed position in which it entirely covers entrance opening 270 and an open position which allows access to entrance opening 270 as well as entrance opening 110.

The operation of trash container assembly 100 is now described. As previously noted, straps 104 and 106 (FIG. 10) may be used to secure the receptacle 102 to the back of a seat as previously described and shown in FIG. 1 with respect to system 10. Main lid 138 is pivotally movable between its closed position of FIG. 10 to its open position of FIG. 12 in order to install and remove trash bag 112 to and from interior chamber 108 where it hangs from hooks 174 and 222 and is thus configured in the expanded position to receive trash via entrance opening 126 into interior chamber 124. While trash may be inserted into bag 112 by opening main lid 138, it is preferred that main lid 138 remain in the closed position while second lid 140 along with wipes container 142 is pivoted to its open position (FIG. 14) whereby opening 270 of main lid serves as the entrance opening for receiving trash therethrough into interior chambers 124 of bag 112 and 108 of receptacle 102. To that effect, latching member 284 is manually released from latching member 268 to allow second lid 140 and wipes container 142 to pivot to its open position. As shown in FIG. 13, lid 144 of wipes container 142 may be open to access wipes 28 via opening 312 while main lid 138 and second lid 140 are in their respective closed positions.

To move receptacle 102 from its expanded position to its fully collapsed position, latch members 266 are manually manipulated to disengage from top wall 184 from within openings 198 (FIG. 12) so that main lid 138 is pivoted upwardly to its open position (FIG. 15) along with second lid 140 and wipes container 142. The opening of main lid 138 allows for the collapsing of sidewalls 134 and 136 which is prevented when lid 138 is in its closed position of FIG. 10. With main lid 138 and rear wall 132 unlatched from one another, rear wall 132 may be pushed forward toward front wall 130 as indicated by Arrow F in FIG. 16 so that the respective panels 252 begin folding at folds D and E. The continued forward movement of rear wall 132 results in a latching engagement (FIG. 17) between latching members 180 and 232. This latching engagement is reached by a sliding engagement between members 180 and 232 in which one or both of them flex away from the other and then snap into the latching engagement as a downwardly projecting tab of member 180 snaps into opening 234. When collapsible walls 134 and 136 reach this fully collapsed position, terminal edges 162 and 192 of the respective outer perimeter walls of front wall 130 and rear wall 132 are disposed closely adjacent one anther or abut one another (FIGS. 17A, 18, 19) along a U-shaped interface extending along the perimeter sidewalls and bottom perimeter walls. In the fully collapsed position, cavity 170 of front wall 130 and cavity 200 of rear wall 132 communicate with one another to form an interior chamber 322 (FIG. 17) bounded by the various walls of front wall 130 and rear wall 132.

Once walls 134 and 136 are fully collapsed, main lid 138 is pivoted downwardly about hinge 262 (Arrow G in FIG. 17) along with second lid 140 and wipes container 142 so that latching members 266 on main lid 138 pass respectively through openings 224 to respectively engage latch members 226 to form a latching engagement therebetween, thus securing main lid 138 and the components carried thereby in a closed or collapsed position of lid 138. Latching members 226 are spaced downwardly from the top of rear wall 132 and openings 198 a short distance more than half way to the bottom of rear wall 132 so that the latching engagement between the respective members 226 and 266 occurs at the same location. More particularly, main lid 138 and the components carried thereby rotate downwardly and forward approximately 90 degrees relative to the closed position of lid 138 in the expanded position of receptacle 102 so that rear wall 256 and sidewalls 258 and 260 respectively abut or are closely adjacent lower wall portion 206 and first and second sidewall portions 210 and 212 of base wall 182. In addition, the portion of base 286 of container 140 which projects inwardly beyond main wall 138 is received within recess 204, as are a portion of interior chamber 300 of wipes container 140 and some of wipes 28. Thus, bottom wall 290 and portions of the other walls of base 286 are disposed forward of base wall 182 in the fully collapsed position, as are a portion of interior chamber 300 and a number of wipes 28. The 90 degree rotation of main lid 138, 140 and container 142 from the closed position of main lid 138 in the expanded position of receptacle 102 (FIG. 10) to the fully collapsed position of receptacle 102 (FIG. 17) thus also alters the relative angle of the components of main lid 138, second lid 140 and container 142 relative to the various structures of front and rear walls 130 and 132. For instance, while lids 138, 140 and 144 along with various other components of container 142 are substantially perpendicular to walls 130 and 132 in the closed position of main lid 138 in the expanded position of receptacle 102, these components are substantially parallel to walls 130 and 132 in the fully collapsed position of receptacle 102 and closed position of lid 138.

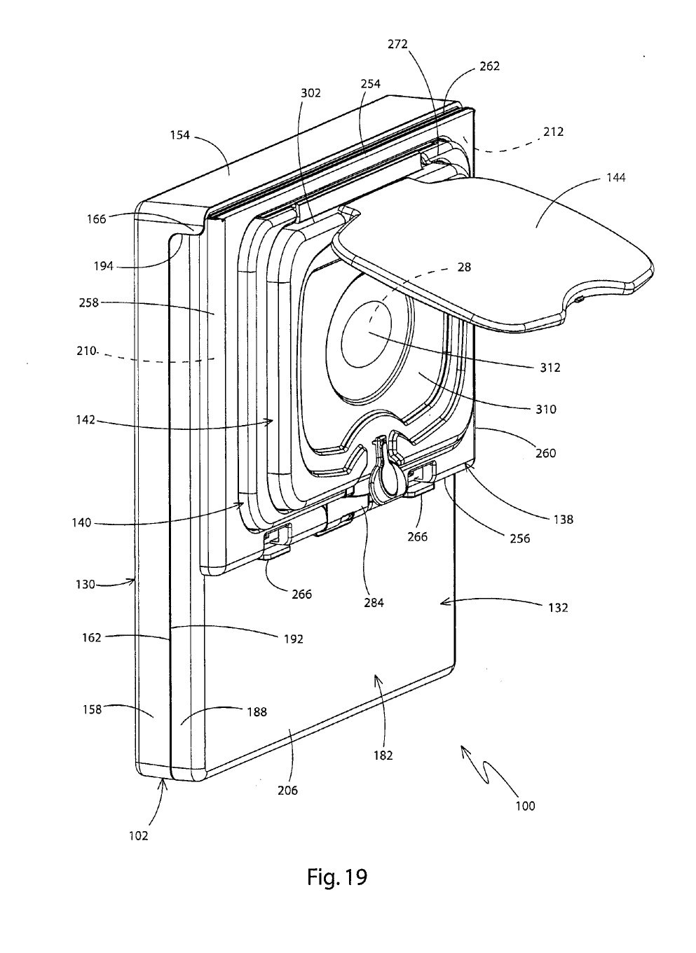

In the fully collapsed position, various components of receptacle 102 are fully enclosed by walls 130 and 132 within interior chamber 322, including folding bottom wall 146 and its associated pivots, mounting bracket 176 and 228, hooks 176 and 222 and trash bag 112. In addition, latch members 226 extend through openings 224 into interior chamber 322, primarily within cavity 200. Recessed wall 202 of rear wall 132 is within or partially within cavity 170 of front wall 130 in the fully collapsed position. During the movement between the expanded and collapsed positions of walls 134 and 136, bottom wall 146 also moves from an expanded or unfolded position (FIG. 11) to a collapsed or folded position (FIG. 17) in response to the movement of rear wall 132 toward front wall 130. During this movement, hinge 236 and pivot 238 moves upwardly as pivot 230 moves from a position distal pivot 170 toward pivot 170 along a substantially horizontal path in the forward direction. Thus, bottom wall panels 148 and 150 move from a shallow V-shaped configuration in which panels 148 and 150 angle upwardly toward one another at a small angle relative to horizontal to an inverted V-shaped configuration in the collapsed position in which panels 148 and 150 define therebetween a small acute angle and are nearly vertical with pivots 176 and 230 adjacent one another. As shown in FIG. 17A, inner folds D of sidewall 134 are adjacent and spaced outwardly from first side edges 240 of panels 148 and 150 on one of side of receptacle 102 in the collapsed position. Likewise, FIG. 17A shows inner folds D of sidewall 136 on the opposite side of receptacle 102 adjacent and spaced outwardly from second side edges 242 of panels 148 and 150. Outer folds E of first accordion wall 134 are adjacent one or both of perimeter sidewalls 158 and 188 while outer folds E of accordion wall 136 are adjacent one or both of outer perimeter walls 160 and 190. FIG. 18 illustrates lid 144 in a closed position when receptacle 102 is in its fully collapsed position while FIG. 19 shows lid 144 pivoted to an open position while the remainder of receptacle 102 remains in the fully collapsed position in order to provide access to wipes 28 via access opening 312. Thus, wipes 28 are accessible via the opening of lid 144 both when receptacle 102 is in the expanded position and the fully collapsed position.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A trash container assembly for use with a seat assembly having a seat and a back extending upwardly therefrom, the trash container assembly comprising:
a trash receptacle movable between expanded and collapsed positions; and
a seat mount adapted for mounting the receptacle on the back of the seat assembly.

2. The trash container assembly of claim 1 wherein the receptacle comprises a collapsible wall.

3. The trash container assembly of claim 2 wherein the collapsible wall is an accordion type wall.

4. The trash container assembly of claim 2 wherein the receptacle comprises a first rigid wall connected to the collapsible wall.

5. The trash container assembly of claim 4 wherein the receptacle comprises a second rigid wall connected to the collapsible wall.

6. The trash container assembly of claim 1 further comprising a trash bag disposed within the receptacle.

7. The trash container assembly of claim 1 further comprising a first lid connected to the receptacle.

8. The trash container assembly of claim 7 further comprising a first releasable connection between the first lid and receptacle in the expanded position; and a second releasable connection between the first lid and receptacle in the collapsed position.

9. The trash container assembly of claim 8 wherein the first lid is positionable atop the receptacle in the expanded position and beside the receptacle in the collapsed position.

10. The trash container assembly of claim 9 wherein the receptacle comprises a first rigid wall having upper and lower ends; the first connection is adjacent the upper end of the first wall; and the second connection is spaced downwardly from the upper end of the first wall.

11. The trash container assembly of claim 8 further comprising a first rigid wall on the receptacle; upper and lower ends on the first wall; and first and second ends on the lid; and wherein the first end of the lid is adjacent the upper end of the first wall in the expanded position; and the second end of the lid is adjacent the upper end of the first wall in the collapsed position.

12. The trash container assembly of claim 8 further comprising a compartment carried by the first lid.

13. The trash container assembly of claim 8 wherein the first lid is movable relative to the receptacle between open and closed positions; and further comprising a second lid connected to the first lid and movable relative to the first lid between open and closed positions.

14. The trash container assembly of claim 13 further comprising a compartment carried by the second lid.

15. The trash container assembly of claim 1 wherein the seat mount comprises a first strap mounted on the receptacle.

16. The trash container assembly of claim 1 further comprising a compartment mounted on the receptacle.

17. The trash container assembly of claim 16 wherein the compartment is pivotally mounted on the receptacle.

18. The trash container assembly of claim 16 further comprising a plurality of pre-moistened wipes disposed in the compartment.

19. The trash container assembly of claim 16 wherein the compartment is positionable atop the receptacle in the expanded position and beside the receptacle in the collapsed position.

20. The trash container assembly of claim 19 wherein the receptacle comprises a sidewall defining a recessed area in which the compartment is received in the collapsed position.
